(19) United States
(12) Patent Application Publication
(10) Pub. No.: US 2013/0159756 A1
(43) Pub. Date: Jun. 20, 2013

(54) Methods And Systems For Blind Analysis of Resource Consumption

(71) Applicant: Daniel P.W. Ellis, New York, NY (US)

(72) Inventor: Daniel P.W. Ellis, New York, NY (US)

(21) Appl. No.: 13/634,568

(22) PCT Filed: Mar. 17, 2011
(86) PCT No.: PCT/US11/28808

§ 371 Date: Nov. 13, 2012

Related U.S. Application Data
(60) Provisional application No. 61/314,843, filed on Mar. 17, 2010.

(51) Int. Cl. G06F 1/28

(52) U.S. Cl. CPC G06F 1/28
USPC 713/340

(57) ABSTRACT

Methods and systems for analyzing gross resource consumption data to determine resource consumption of individual devices are disclosed. In some embodiments, the methods and methods include the following: obtaining a first data that includes a time series of a gross resource consumption for a location; using blind signal separation techniques, identifying power-on and power-off events within the first data, the events being caused by turning particular devices at the location on and off during the time series and each of the events reflecting a power consumption signature for each of the particular devices; associating each of the events with a known device, the known device being substantially similar to one of the particular devices at the location; and determining a portion of the gross resource consumption consumed by each of the particular devices.

### CROSS REFERENCE TO RELATED APPLICATION(S)

This application claims the benefit of U.S. Provisional Application No. 61/314,843, filed Mar. 17, 2010, which is incorporated by reference as if disclosed herein in its entirety.

### BACKGROUND

Energy efficiency improvements rely on specific information about how resources such as electrical energy and water are currently consumed, yet for many consumers data is only available at coarse, aggregate levels such as entire floors or buildings. Utility metering data can provide detailed temporal breakdown of total resource usage, but this still requires a significant amount of guessing or detective work before the specific appliances or locations responsible for each portion of the resource consumption can be identified.

In an effort towards conserving electricity, reducing costs, and increasing reliability and transparency, many antiquated electricity grids are being modernized to support intelligent monitoring and power delivery in accordance with the smart grid paradigm. Smart meters represent a key component of smart grid monitoring systems. Although current smart meter technology is capable of reporting energy consumption in much greater detail than conventional meters, the granularity of the data collected is typically limited to coarse, aggregate levels in these devices. Smart meters and derived services such as Google's PowerMeter keep track of aggregate usage in whole households, but identifying individual power using appliances below that level is currently just guesswork.

### SUMMARY

Methods and systems according to the disclosed subject matter relate to systems and methods of more precisely measuring energy consumption. Some embodiments of the disclosed subject matter include systems and methods for analyzing gross resource consumption data to determine resource consumption of individual devices. Inference and machine learning such as blind signal separation techniques, which were originally developed for analyzing single-channel sound mixtures that each similarly represent a linear combination of many sources, each of which are described by some signature behavior, allow for a more detailed analysis of power consumption to pinpoint the energy use of individual appliances or rooms.

In some embodiments where instances of different devices with near-identical power consumption can become confused, they can be disambiguated by the addition of a small, inexpensive device to make their power consumption more identifiable. Inference and machine learning such as blind signal separation techniques can then be employed with a higher degree of success.

### BRIEF DESCRIPTION OF THE DRAWINGS

The drawings show embodiments of the disclosed subject matter for the purpose of illustrating the invention. However, it should be understood that the present application is not limited to the precise arrangements and instrumentalities shown in the drawings, wherein:

FIG. 1 is a schematic diagram of a system according to some embodiments of the disclosed subject matter.

FIG. 2 is a chart of a method according to some embodiments of the disclosed subject matter;

FIGS. 3A-3C are charts of resource consumption data according to some embodiments of the disclosed subject matter; and

FIG. 4 is a schematic diagram of a resource metering apparatus according to some embodiments of the disclosed subject matter.

### DETAILED DESCRIPTION

Technology according to the disclosed subject matter employs blind signal separation techniques to break down summed resource consumption data into contributions of different devices. Each individual appliance or lighting configuration has a specific energy vs. time signature when it turns on or off. Most devices have near-stationary power consumption most of the time and most devices turn on or off without synchronization to other devices. As a result, using systems and methods according to the disclosed subject matter, detailed time series describing the sum total power of a large number of devices are decomposed into a sequence of on/off events attributed to the individual devices. From there, the amount of resources consumed by each of the devices over a time period can be determined.

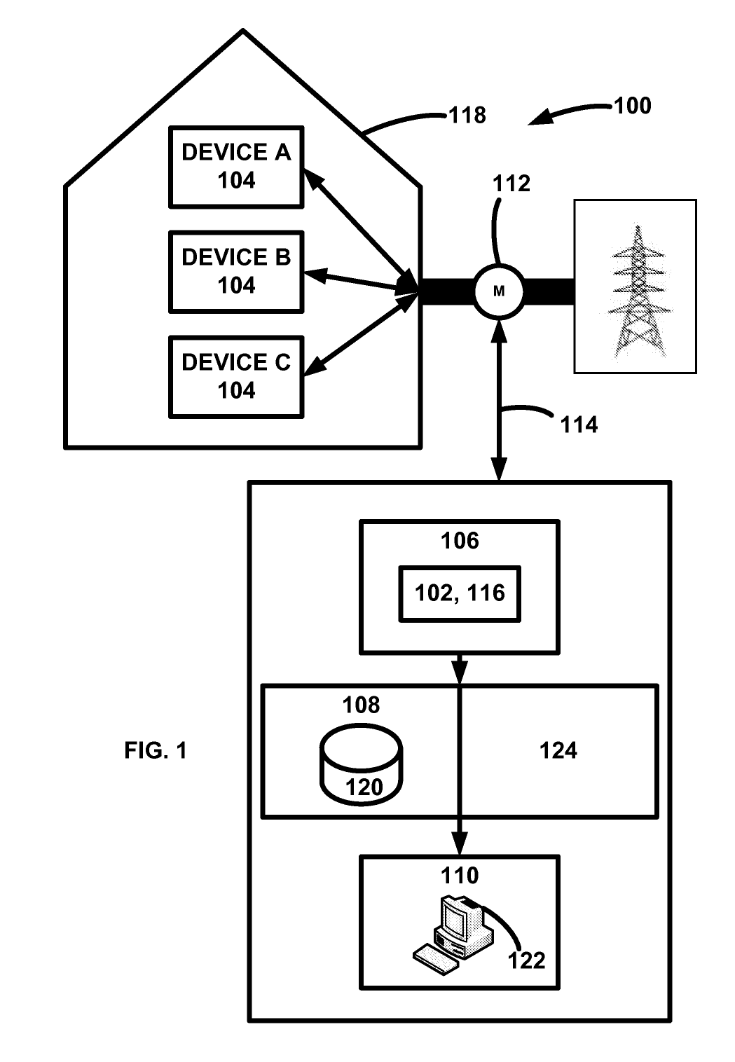

Referring now to FIGS. 1-4, some embodiments include systems and methods for analyzing resource consumption data. Some embodiments include a system 100 for analyzing gross resource consumption data 102 to determine resource consumption of individual devices 104. Typically, but not always, at least one of the plurality of devices is a household appliance and the resource is one of electricity and water. Some embodiments of system 100 include a power consumption measurement module 106, a power consumption database 108, and a power consumption analysis module 110, all of which interact with one another.

Referring now to FIG. 1, power consumption measurement module 106 includes either a metering apparatus 112 or a data feed 114 that allows it to obtain a first data 116 including a time series of gross resource consumption for a location 118. The time series includes resource consumption of a plurality of devices 104 at location 118.

Power consumption database 108 includes a second data 120. Second data 120 typically includes, among other information, predetermined resource consumption signatures for each of the plurality of devices 104 and known average resource consumption data for each of the plurality of devices. Typically, but not always, resource consumption signatures are based on a measurement of resource consumption by each of the plurality of devices 104 vs. time when it turns on or off. For system 100, a majority of the plurality of devices 104 have substantially stationary resource consumption a majority of the time and a majority of the plurality of devices turn on or off without synchronization to any other of the plurality of devices.

Power consumption analysis module 110 includes a computer processor 122 that processes instructions that prescribe the utilization of blind signal separation techniques to analyze the first and second data 116, 120 to develop a sequence of events each of which are attributed to one of the plurality of devices 104. The sequence of events forms a third data, which is used to determine what portion of the gross resource consumption is consumed by each of the plurality of devices. More specifically, in some embodiments, the portion of the gross resource consumption consumed for each of the plurality of devices is calculated using the third data and the known average resource consumption data for each of the plurality of devices.

In some embodiments, system 100 includes a resource consumption marker module 124. Module 124 adds resource consumption identifiers to devices 104 to enhance their resource consumption signatures. Module 124 is used in situations where instances of different devices with near-identical power consumption might become confused. These instances can be disambiguated by the addition of a small, cheap resource consumption identifier device to make their power consumption more identifiable. These devices, if they are necessary at all, are much cheaper than deploying individual power-consumption-recording units at the point of each appliance or lighting fixture. In some embodiments, a simple resistor to minutely alter the total power consumption is used, although more complex devices that modulate power consumption at power-on could fully disambiguate power usage records.

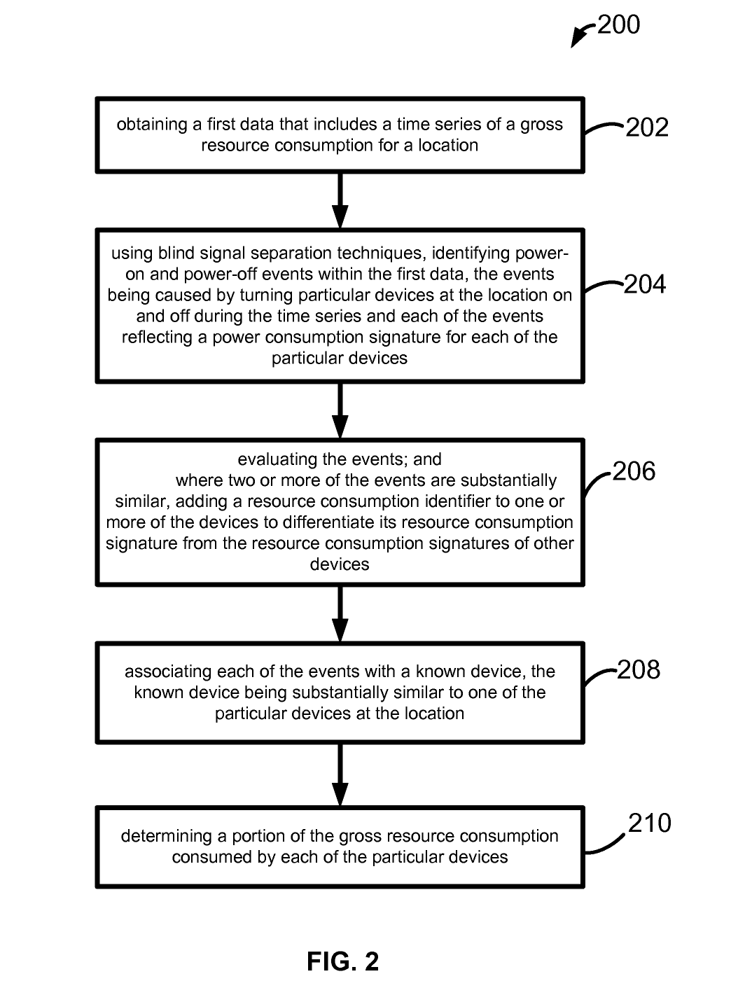

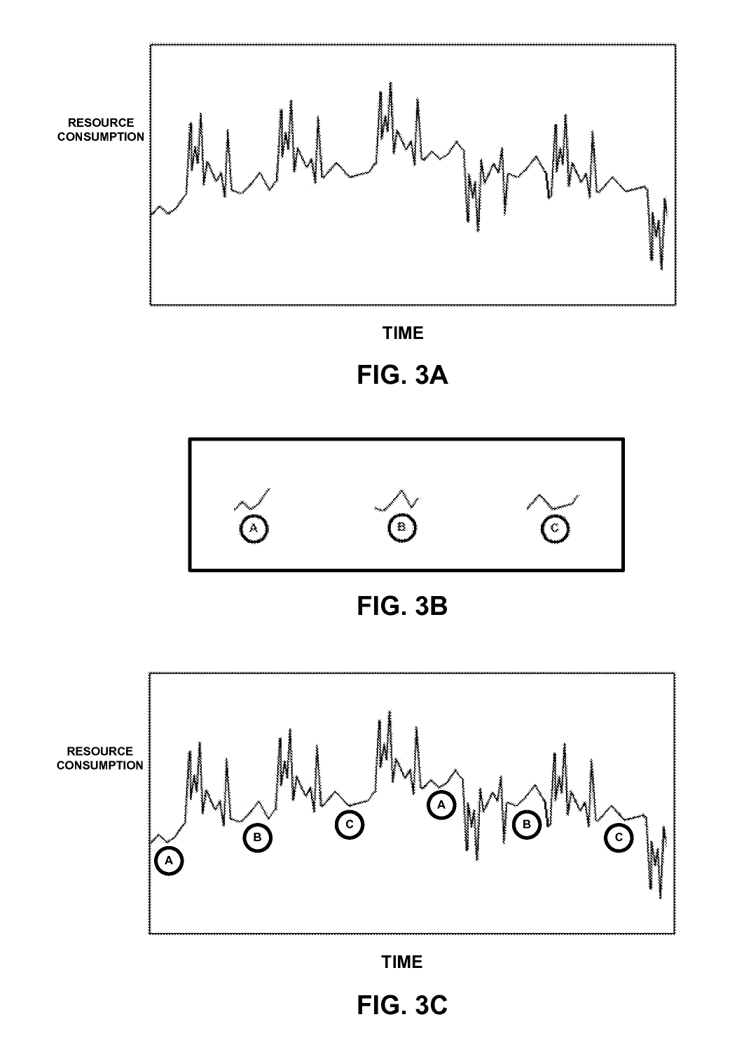

Referring now to FIGS. 2 and 3, some embodiments include a method 200 of analyzing gross resource consumption data to determine resource, e.g., electricity or water, consumption of individual devices, e.g., household appliances. At 202, a first data that includes a time series of gross resource consumption for a location is obtained. First data is best shown in FIG. 3A.

At 204, using blind signal separation techniques, identifying power-on and power-off events are identified within the first data. Particular blind signal separation techniques used include those well known in the art, e.g., clustering algorithms such as k-means and nonnegative matrix factorization. The blind signal separation techniques identify repeating common patterns, i.e., events, of resource consumption change, indicating specific devices. In some embodiments, known blind signal separation technique shift-invariant semi non-negative matrix factorization is used.

The events are caused by turning particular devices at the location on and off during the time series. Each of the events depicts a power consumption signature for each of the particular devices, which is based on a measurement of resource consumption by each of the particular devices vs. time when it turns on or off. Typically, but not always, a majority of the devices have substantially stationary resource consumption a majority of the time and a majority of the devices turn on or off without synchronization to any other of the devices.

At 206, the events are evaluated and where two or more of the events are substantially similar, a resource consumption identifier is added to one or more of said devices to differentiate its resource consumption signature from the resource consumption signatures of other devices.

At 208, each of the events is associated with a known device, which is substantially similar to one of the particular devices at the location. In some embodiments, associating each of the events with a known device includes matching the power consumption signatures of the particular devices with substantially similar known power consumption signatures of known devices. In some embodiments, associating each of the events with a known device includes providing power consumption signatures of the devices at the location and matching the power consumption signatures of the particular devices with substantially similar power consumption signatures of the devices at the location.

In some embodiments, providing power consumption signatures of the devices at the location includes an interactive process in which a user, e.g., the owner of the location, “teaches” the power consumption signatures of the one or more devices at the location by turning them on or off, in response to system prompts.

For example, referring now to FIG. 3B, resource consumption signatures having a particular energy vs. time profile, e.g., signatures A, B, and C, are illustrated. Signatures A, B, and C can be either known power consumption signatures of known devices or power consumption signatures of the devices at the location. Referring now to FIG. 3C, power consumption signatures substantially similar to power consumption signatures A, B, and C are identified within first data.

At 210, a portion of the gross resource consumption consumed by each of the particular devices is determined. The portion of the gross resource consumption consumed for each of the particular devices is typically calculated using data duration of its event and known average resource consumption data for each of the associated known devices. For example, referring again to FIG. 3C, where the resource is electricity, if it is determined that an air conditioner \textcircled{C} was on for a duration of 10 hours, e.g., the time between the first occurrence of \textcircled{C} and the second occurrence of \textcircled{C}, during a given month and the known average resource consumption data for the air conditioner is 0.3 kW/hour, it can be determined that the air conditioner consumed 3 kW of electricity during the month. Further, if the gross resource consumption data shows that 10 kW of electricity were used, it can be determined that 30% of the electricity consumed during the month was by a particular appliance such as the air conditioner.

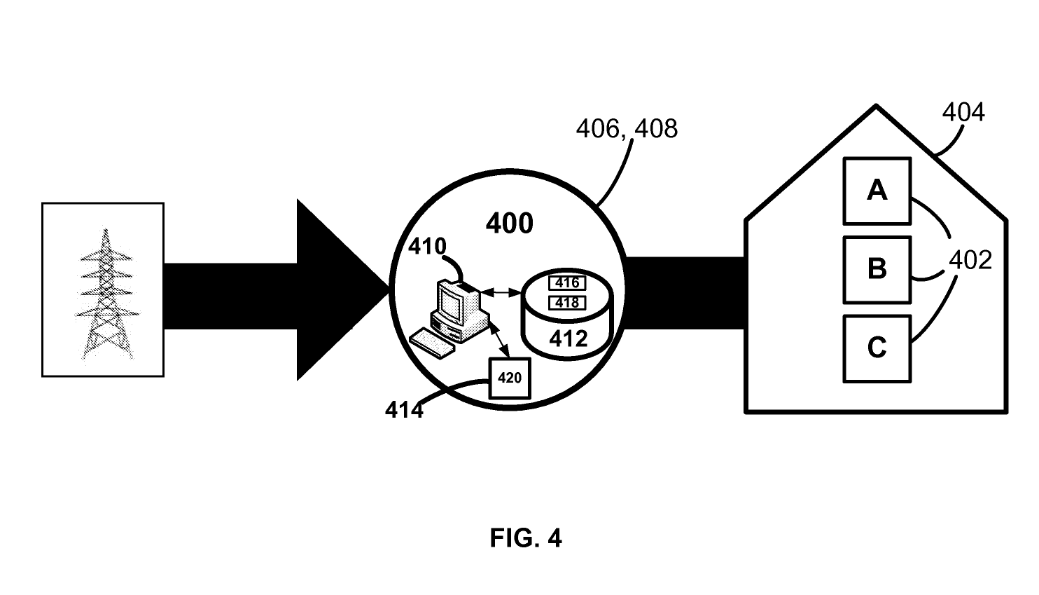

Referring now to FIG. 4, some embodiments include a metering apparatus 400 for analyzing gross resource consumption data to determine resource consumption of individual devices 402 at a location 404. In some embodiments, apparatus 400 includes a housing 406 that contains a mechanism 408, a computer processor 410, a database 412, and a computer-readable medium 414, all of which interact to determine the resource consumption of individual devices 402 at a location 404.

Mechanism 408 is used to connect apparatus 400 with location 404 for obtaining a first data that includes a time series of gross resource consumption for the location. The time series includes resource consumption of a plurality of devices 402 at location 404.

Database 412 is in communication with computer processor 410 and includes predetermined resource consumption signatures 416 for each of the plurality of devices 402 and known average resource consumption data 418 for each of the plurality of devices. The resource consumption signatures 416 are typically based on a measurement of resource consumption by each of the plurality of devices vs. time when it turns on or off. The known average resource consumption data 418 is typically obtained from manufacturers of devices 402 and/or industry groups related to the manufacture of such devices. Resource consumption signatures 416 and known average resource consumption data 418 represent second and third data, respectively.

Computer-readable medium 414 has computer-executable instructions 420 that are executed by computer processor 410. Instructions 420 include the following: using blind signal separation techniques, analyzing the first and second data to develop a sequence of events each of which are attributed to one of the plurality of devices, the sequence comprising a fourth data; and using the third and fourth data, determining a portion of the gross resource consumption consumed by each of the plurality of devices.

Smart meters can measure power consumption only at coarse scales, e.g., whole buildings. Technology according to the disclosed subject matter uses inference and machine learning to allow more detailed analysis of power consumption to pinpoint the energy use of individual appliances or rooms without installing costly measurement equipment at every point of consumption. Technology according to the disclosed subject matter provides a specific, detailed breakdown of the aggregate power usage from a smart meter in terms of multiple, individual devices within the home or building. Using technology according to the disclosed subject matter, one can find out exactly how much power each device, e.g., bedroom lights, toaster, computer, is using averaged over long periods. Figuring out where electrical energy is being used helps target efforts at electrical energy conservation.

Other possible commercial applications for technology according to the disclosed subject matter include: (1) analysis of power consumption in other applications where a single power feed is shared between multiple consumers; (2) attribution of consumption in other situations where (a) total consumption is measured only at an aggregate level, but as a linear combination of individual contributions, and (b) individual contributions change in discrete but predictable and idiosyncratic increments; and (3) analysis of water usage.

Although the disclosed subject matter has been described and illustrated with respect to embodiments thereof, it should be understood by those skilled in the art that features of the disclosed embodiments can be combined, rearranged, etc., to produce additional embodiments within the scope of the invention, and that various other changes, omissions, and additions may be made therein and thereto, without parting from the spirit and scope of the present invention.

What is claimed is:

1. A method of analyzing gross resource consumption data to determine resource consumption of individual devices, said method comprising:
obtaining a first data that includes a time series of a gross resource consumption for a location;
using blind signal separation techniques, identifying power-on and power-off events within said first data, said events being caused by turning particular devices at the location on and off during said time series and each of said events reflecting a power consumption signature for each of said particular devices;
associating each of said events with a known device, said known device being substantially similar to one of said particular devices at the location; and
determining a portion of said gross resource consumption consumed by each of said particular devices.

2. The method of claim 1, wherein associating each of said events with a known device further comprises matching said power consumption signatures of said particular devices with substantially similar known power consumption signatures of known devices.

3. The method of claim 1, wherein associating each of said events with a known device further comprises:
providing power consumption signatures of said devices at the location; and
matching said power consumption signatures of said particular devices with substantially similar power consumption signatures of said devices at the location.

4. The method of claim 1, wherein said portion of said gross resource consumption consumed for each of said particular devices is calculated using a duration of its event and known average resource consumption data for each of said associated known devices.

5. The method of claim 1, wherein a majority of said plurality of devices have substantially stationary resource consumption a majority of the time.

6. The method of claim 1, wherein a majority of said plurality of devices turn on or off without synchronization to any other of said plurality of devices.

7. The method of claim 1, further comprising:
evaluating said events; and
where two or more of events are substantially similar, adding a resource consumption identifier to one or more of said devices to differentiate its resource consumption signature from said resource consumption signatures of other devices.

8. The method of claim 1, wherein said resource is one of electricity and water.

9. A system for analyzing gross resource consumption data to determine resource consumption of individual devices, said system comprising:
a power consumption measurement module for obtaining a time series of a gross resource consumption for a location, said time series including resource consumption of a plurality of devices at the location, said time series representing a first data;
a power consumption database including resource consumption signatures for each of said plurality of devices and known average resource consumption data for each of said plurality of devices, said resource consumption signatures representing a second data; and
a power consumption analysis module for using blind signal separation techniques to analyze said first and second data to develop a sequence of events each of which are attributed to one of said plurality of devices, said sequence comprising a third data, and using said third data, determining a portion of said gross resource consumption consumed by each of said plurality of devices.

10. The system of claim 9, further comprising:
a resource consumption marker module including resource consumption identifiers for adding to devices to enhance their resource consumption signatures.

11. The system of claim 9, wherein said resource consumption signature is based on a measurement of resource consumption by each of said plurality of devices vs. time when it turns on or off

12. The system of claim 9, wherein said portion of said gross resource consumption consumed for each of said plurality of devices is calculated using said third data and said known average resource consumption data for each of said plurality of devices.

13. The system of claim 9, wherein a majority of said plurality of devices have substantially stationary resource consumption a majority of the time.

14. The system of claim 9, wherein a majority of said plurality of devices turn on or off without synchronization to any other of said plurality of devices.

15. The system of claim 9, wherein at least one of said plurality of devices is a household appliance.

16. The system of claim 9, wherein said resource is one of electricity and water.

17. A metering apparatus for analyzing gross resource consumption data to determine resource consumption of individual devices, said apparatus comprising:
a housing;
a mechanism for connecting said apparatus with a location for obtaining a first data that includes a time series of a gross resource consumption for said location, said time series including resource consumption of a plurality of devices at said location;
a computer processor;
a database in communication with said computer processor, said database including resource consumption signatures for each of said plurality of devices and known average resource consumption data for each of said plurality of devices, said resource consumption signatures and said known average resource consumption data representing second and third data, respectively; and
a computer-readable medium having the following computer-executable instructions that are executed by said computer processor:
using blind signal separation techniques, analyzing said first and second data to develop a sequence of events each of which are attributed to one of said plurality of devices, said sequence comprising a fourth data; and
using said third and fourth data, determining a portion of said gross resource consumption consumed by each of said plurality of devices.

18. The apparatus of claim 17, wherein said resource consumption signature is based on a measurement of resource consumption by each of said plurality of devices vs. time when it turns on or off.

19. The apparatus of claim 17, wherein said resource is one of electricity and water.

20. The apparatus of claim 17, wherein at least one of said plurality of devices is a household appliance.
